(19) United States
(12) Patent Application Publication
(10) Pub. No.: US 2021/0187558 A1
(43) Pub. Date: Jun. 24, 2021

(54) GRILL CLEANER AND METHOD OF CLEANING A GRILL

(71) Applicants: Kiel Webb, Waterloo (CA); Colin Kirvan, Waterloo (CA); Terry Witzel, Waterloo (CA)

(72) Inventors: Kiel Webb, Waterloo (CA); Colin Kirvan, Waterloo (CA); Terry Witzel, Waterloo (CA)

(21) Appl. No.: 17/128,818

(22) Filed: Dec. 21, 2020

Related U.S. Application Data
(60) Provisional application No. 62/950,283, filed on Dec. 19, 2019.

(51) Int. Cl. B08B 1/00; A47J 37/07; A47L 13/34; F25C 1/22

(52) U.S. Cl. CPC B08B 1/001; F25C 1/22; A47L 13/34; A47J 37/0786

(57) ABSTRACT

Disclosed is a grill cleaner having a head, a handle and an ice mount. The handle is coupled to and extends from the head. The handle is oriented for use in driving the head in a grill cleaning operation. The ice mount is coupled to the head and has an ice support extending from the head to be embedded within and support a block of ice.

### CROSS-REFERENCE TO RELATED PATENT APPLICATION

This application claims the benefit of U.S. Provisional Application No. 62/950,283, filed on Dec. 19, 2019. The complete disclosure of U.S. Provisional Application No. 62/950,283 is incorporated herein by reference.

### TECHNICAL FIELD

The described embodiments relate to a grill cleaner, particularly a grill cleaner for use with an ice block.

### BACKGROUND

U.S. Pat. No. 5,924,460 purports to disclose a device for cleaning a barbeque grill comprising a block of ice having a wedge-shaped cross-section at one end and handle of temperature insulating material at the other.

U.S. Pat. No. 6,216,306 purports to disclose a grill cleaning brush and scraper having a replaceable cleaning bristle head with scraper blade. This application also discloses a second handle grip for improved leverage and force application permits more efficient cleaning with less effort. The device also provides a soft-grip handle and curved neck portion for improved comfort during use.

### BRIEF DESCRIPTION OF THE DRAWINGS

The drawings included herewith are for illustrating various examples of systems, methods, and apparatus of the present specification. In the drawings:

FIG. 1A is a top plan view of a grill cleaner, according to an embodiment;

FIG. 1B is a right side elevation view of the grill cleaner of FIG. 1A;

FIG. 1C is a bottom plan view of the grill cleaner of FIG. 1A;

FIG. 1D is an exploded view of the grill cleaner of FIG. 1A;

FIG. 2A is a top perspective view of a head of the grill cleaner of FIG. 1A;

FIG. 2B is a top plan view of the head of FIG. 2A;

FIG. 2C is a rear elevation view of the head of FIG. 2A;

FIG. 2D is a cross sectional view of the head of FIG. 2A;

FIG. 2E is a bottom plan view of the head of FIG. 2A;

FIG. 3A is a top perspective view of a handle of the grill cleaner of FIG. 1A;

FIG. 3B is a top perspective view of a grip of the handle of FIG. 3A;

FIG. 3C is a top plan view of the grip of FIG. 3B;

FIG. 3D is a front elevation view of the grip of FIG. 3B;

FIG. 3E is a right elevation view of the grip of FIG. 3B;

FIG. 3F is a bottom plan view of the grip of FIG. 3B;

FIG. 3G is a front elevation view of a shaft of the handle of FIG. 3A;

FIG. 3H is a top plan view of the shaft of FIG. 3G;

FIG. 3I is a right elevation view of the shaft of FIG. 3G;

FIG. 4A is a top perspective view of an ice mount of the grill cleaner of FIG. 1A;

FIG. 4B is a bottom perspective view of a socket of the ice mount of FIG. 4A;

FIG. 4C is a bottom plan view of the socket of FIG. 4B;

FIG. 4D is a right elevation view of the socket of FIG. 4B;

FIG. 4E is a rear elevation view of the socket of FIG. 4B;

FIG. 4F is a top elevation view of an ice support of the ice mount of FIG. 4A;

FIG. 4G is a rear elevation view of the ice support of FIG. 4F;

FIG. 4H is a right elevation view of the ice support of FIG. 4F;

FIG. 5A is a perspective view of a grill cleaner system, according to an embodiment;

FIG. 5B is a cross sectional view of the grill cleaner system of FIG. 5A;

FIG. 6A is top perspective view of a tray of the grill cleaner system of FIG. 5A;

FIG. 6B is a cutaway top perspective view of the tray of FIG. 6A;

FIG. 6C is a top plan view of the tray of FIG. 6A;

FIG. 6D is a cross sectional view of the tray of FIG. 6A;

FIG. 6E is a bottom plan view of the tray of FIG. 6A;

FIG. 6F is a right elevation view of the tray of FIG. 6A;

FIG. 6G is a top plan view of a perimeter support of the tray of FIG. 6A;

FIG. 7A is a perspective exploded view of a grill cleaner system, according to an embodiment;

FIG. 7B is a top plan view of a pair of ice mounts of the grill cleaner system of FIG. 7A received in an ice tray of the grill cleaner system of FIG. 7A;

FIG. 7C is a front elevation view of the pair of ice mounts received in the ice tray of FIG. 7B;

FIG. 7D is a cross sectional view of the pair of ice mounts received in the ice tray of FIG. 7B;

FIG. 7E is a top plan view of the tray of FIG. 7B;

FIG. 7F is a front elevation view of the tray of FIG. 7B;

FIG. 7G is a bottom plan view of an ice mount of the grill cleaner system of FIG. 7A;

FIG. 7H is a right elevation view of the ice mount of FIG. 7G; and

FIG. 7I is a front elevation view of the ice mount of FIG. 7G.

### DETAILED DESCRIPTION

Various systems, methods and apparatus will be described below to provide an example of each claimed embodiment. No embodiment described below limits any claimed embodiment and any claimed embodiment may cover systems, methods and/or apparatus that differ from those described below. The claimed embodiments are not limited to systems, methods and apparatus having all of the features of any one system, method and apparatus described below or to features common to multiple or all.

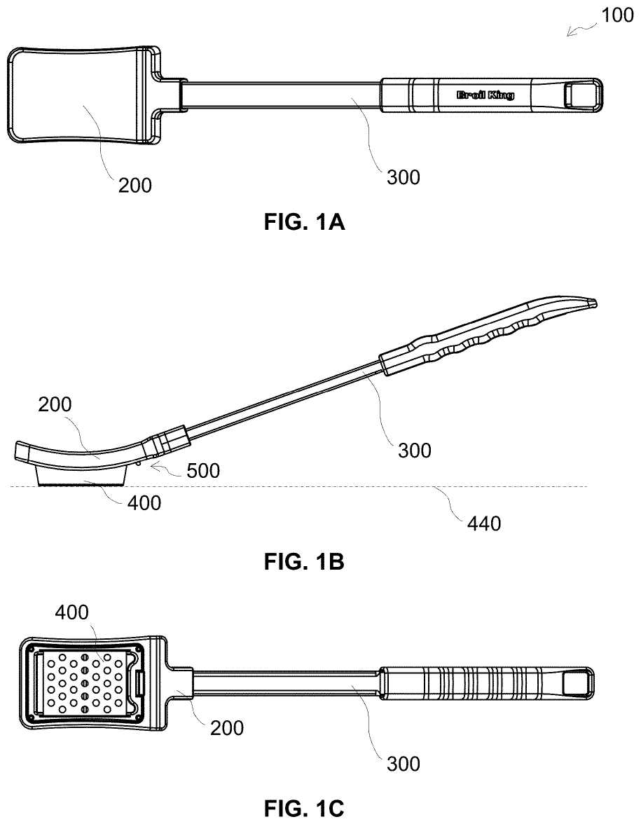

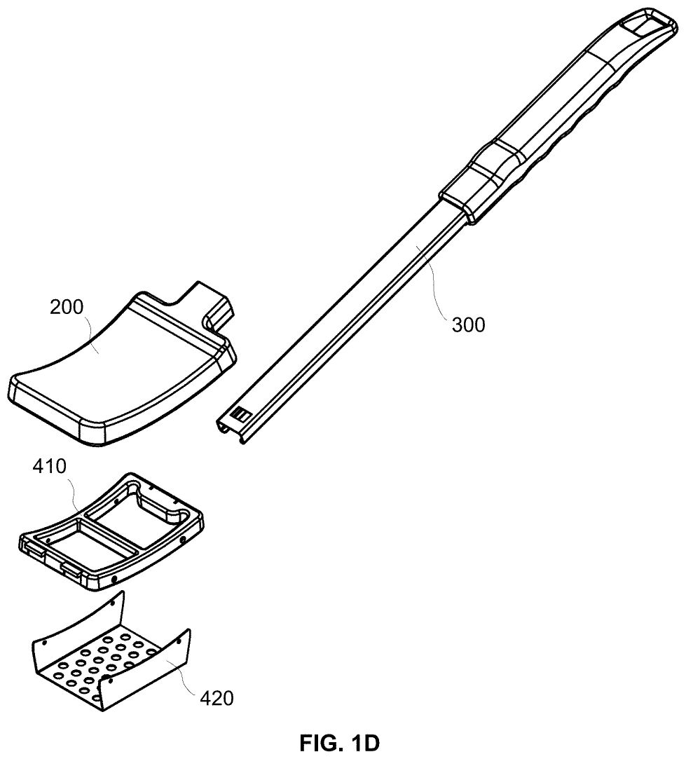

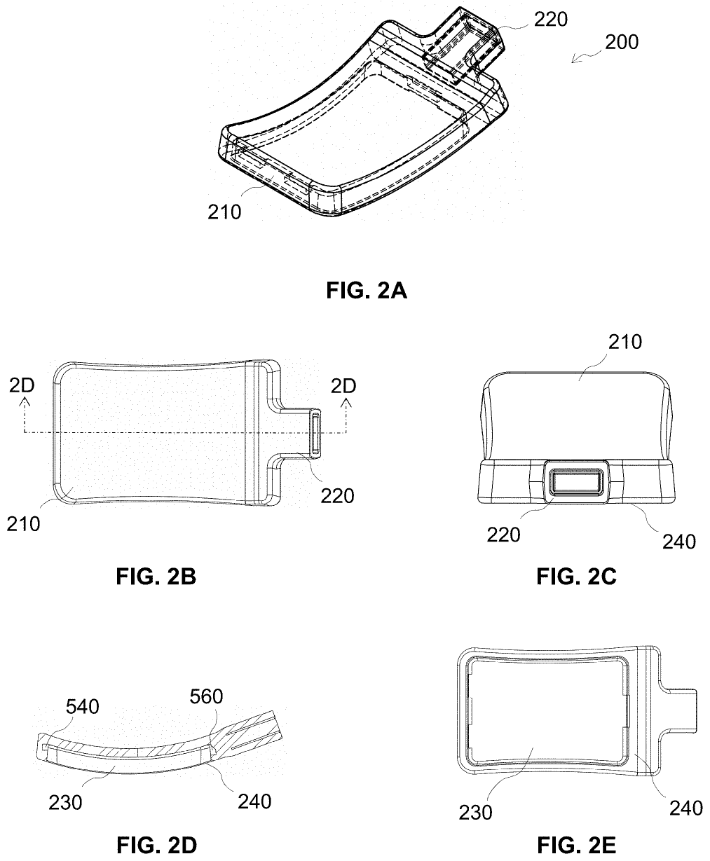

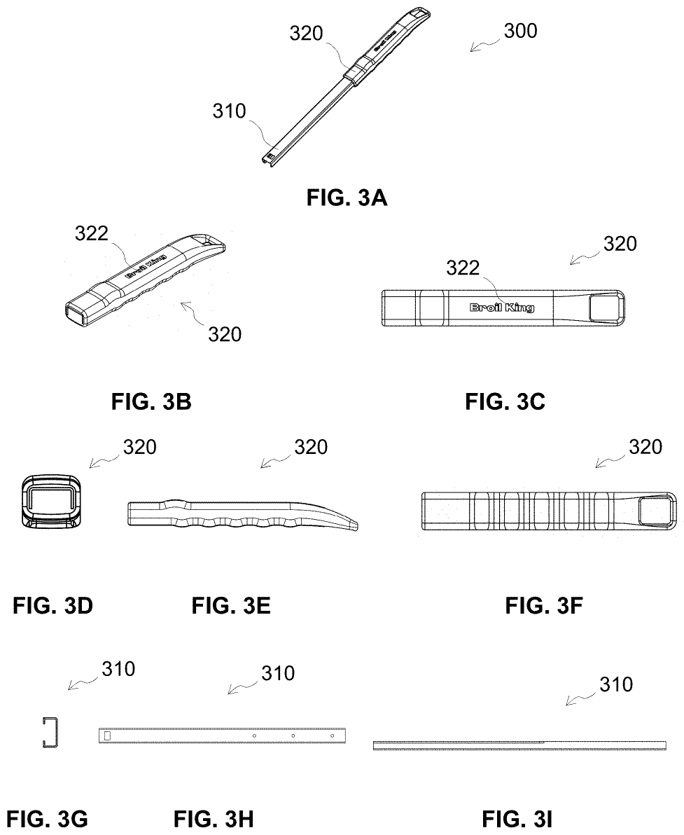

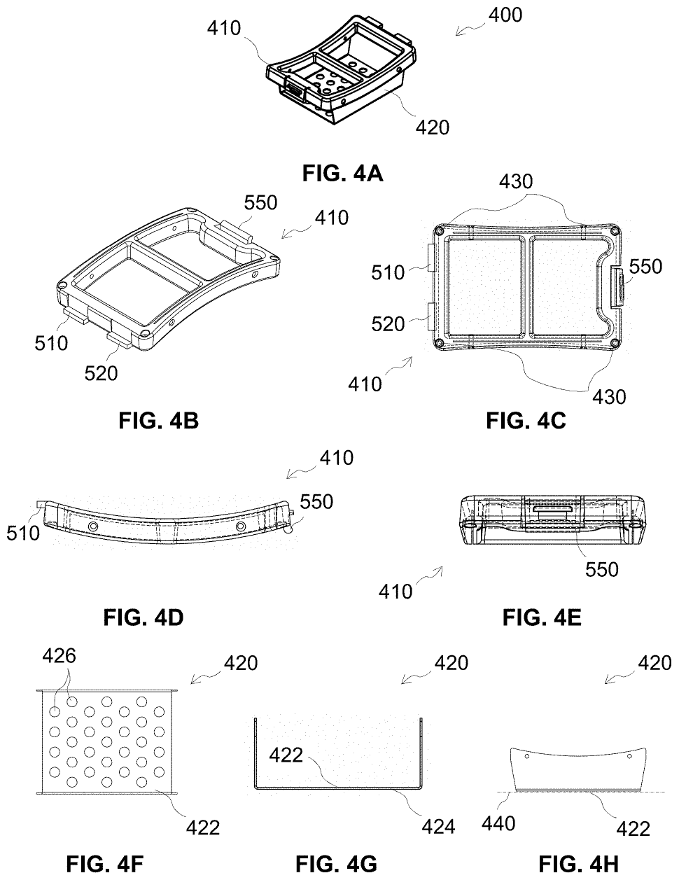

Reference is first made to FIG. 1, showing a grill cleaner 100. Grill cleaner 100 includes a head 200, further detailed in FIG. 2. Grill cleaner 100 also includes a handle 300, further detailed in FIG. 3. Handle 300 is firmly secured to head 200 and extends from head 200. Grill cleaner 100 also includes an ice mount 400, further detailed in FIG. 4.

Head 200 is formed of a synthetic resin and has a forward end 210 and a rear end 220. Head 200 has a socket cavity 230 in a grill facing surface 240 of head 200. Grill facing surface 240 is a generally convexly curved surface. FIG. 2A is a top perspective view of head 200 which shows underside and internal features in outline.

Handle 300 is an elongated handle to allow a user to drive head 200 in cleaning a hot grill without unduly exposing themselves to the heat of the grill by grasping a distal end of handle 300. Handle 300 includes a shaft 310 formed of a stainless steel plate folded to form supporting ribs. Handle 300 also includes a grip 320 formed of a synthetic resin. Handle 300 is fixedly joined to head 200 by an interference fit of a proximal end of shaft 310 in a receiving cavity formed on a rear end 220 of head 200. A distal end of shaft 310 is joined to grip 320 via an interference fit of the distal end of shaft 310 in a receiving cavity formed on a proximal end of grip 320. A logo 322 is formed on grip 320 and finished to a polished gloss, while the remainder of the exterior surface of grip 320 is finished with a textured finish.

Ice mount 400 includes an ice support 420 and a socket insert 410. Insert 410 is formed of a synthetic resin. Ice support 420 is a folded stainless steel plate joined to insert 410 via an interference fit of the vertical legs into receiving cavities of insert 410. Ice support 420 of ice mount 400 defines a head facing surface 422 and a grill facing surface 424. Head facing surface 422 is spaced from grill facing surface 240 of head 200, allowing for the formation of ice between. Ice support 420 includes a set of apertures 426 through from the head facing surface 422 to the grill facing surface 424 to allow the formation of ice through the apertures 426.

Grill facing surface 424 defines an operational plane 440, shown in FIGS. 1B and 4H. Handle 300 forms an oblique angle relative to operation plane 440 to better enable a user to drive head 200 in a grill cleaning operation.

Ice mount 400 is removably joined to head 200 by a spring lock system 500 indicated in FIG. 1B. Insert 410 is sized and shaped to be received in socket cavity 230 and removably held in socket cavity 230 via spring lock system 500.

Spring lock system 500 includes a pair of rigid forward projections 510 and 520 of ice mount 400. Forward projection 510 corresponds to a forward recess (not shown) formed in head 200, while forward projection 520 corresponds to a forward recess 540 formed in head 200. Spring lock system also includes a moveable rear clip 550 of ice mount 400 and corresponding to a rear recess 560 formed in head 200. Rear clip 550 is moveable between a retracted position and an extended position, and is biased by a spring toward the extended position.

Ice mount 400 is removably secured to head 200 when insert 410 is held in socket 230. Insert 410 is held in socket 230 when it is received in socket 230, forward projections 510 and 520 are received in the forward recesses of head 200, and clip 550 is extended into recess 560. Ice mount 400 may be released from head 200 by moving clip 550 into a retracted position, thus freeing insert 410 to be removed from socket 230.

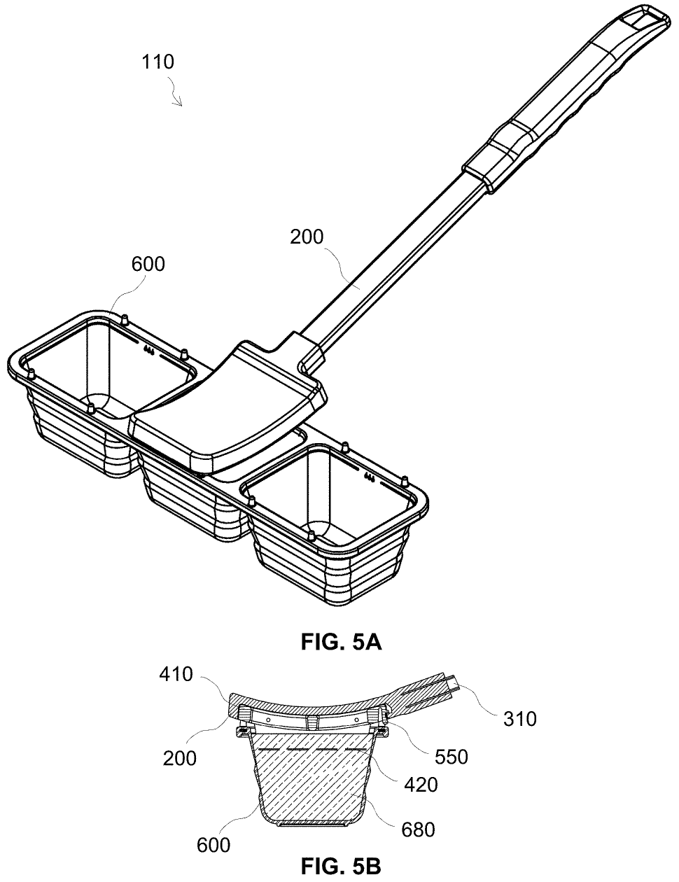

FIG. 5 shows a grill cleaning system 110 that includes a grill cleaner 100 and an ice tray 600. As depicted, ice tray 600 is provided to hold a quantity of water within which ice support 420 is partly immersed. The quantity of water is then to be frozen into a block of ice 680 in which a lower portion of ice support 420 is embedded. With ice support 420 secured to socket insert 410 and embedded in the block of ice, the ice support 400 can be coupled to head 200 and head 200 can be driven by handle 300 to apply the block of ice against a grate of a grill.

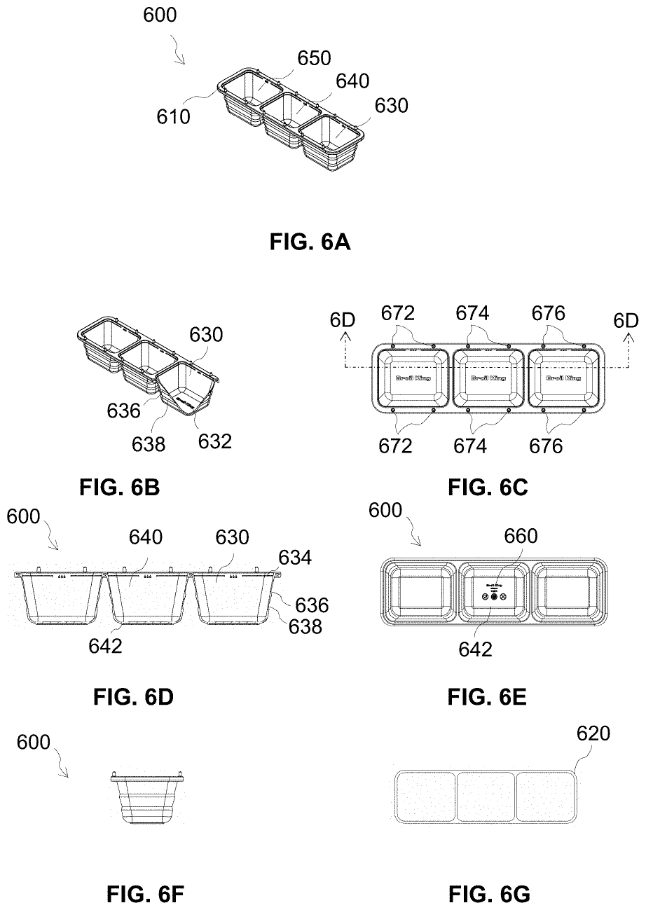

Ice tray 600, further detailed in FIG. 6, is a collapsible tray having a rigid upper rim 610 supported by a brace 620 embedded within rim 610. Brace 620 is formed of cold rolled steel. Tray 600 includes a set of three cups 630, 640, and 650, each of which forms a cavity for holding water and receiving an ice support of an ice mount to be at least partly immersed in the water as the water freezes into a block of ice coupled to the ice support.

Tray 600 is formed of a water resistant material such as flexible silicone, such as a food grade standard silicon suitable for temperatures below −15° C. The walls of each cup 630, 640, and 650 are sloped to allow an ice block formed in the corresponding cavity to be lifted out. The interior surface of the walls of each cavity are polished for a low-friction fit with an ice block formed therein.

A logo-shaped recess, such as recess 632, is molded into an inside face of the bottom of each cup such that an ice block formed in the cavity includes a corresponding logo. Each cup also includes a fill line, such as fill line 634, to indicate how much water should be added to the cavity to fill the cavity prior to receiving an ice support therein.

The walls of each cup include two laterally encircling sections of reduced thickness which form folding sections to allow the tray to be collapsed. For example, cup 630 can be collapsed along first folding section 636 and second folding section 638.

Tray 600 also includes information 660, such as a Food Safe logo and an identification of material used, on an outside face of the bottom of the tray. Each cup also includes a base, such as base 642.

Rim 610 of ice tray 600 includes sets of corner bosses 672, 674, and 676 for use in positioning ice mounts when the ice mounts are received within cavities of the tray. Ice mounts each include a set of corner sockets for use in cooperating with bosses of ice tray 600. For example, corner bosses 674 cooperate with sockets 430 of ice mount 400. As depicted particularly in FIG. 5B, sizing of corner bosses 674, cup 640, and ice mount 400 cooperate to allow for the formation of a block of ice having approximately 10 to 15 percent of the thickness of the block received between head facing surface 422 and grill facing surface 240.

Synthetic resin and stainless steel are used in construction of grill cleaning system 110. The synthetic resin may be for example polypropylene resin, with the resin grade selected to minimize shrink. Visible surfaces of grill cleaner 100 are finished. For example, parts made of synthetic resin are cleared of any flash and stainless steel parts are free of burrs and blemishes. Stainless steel surfaces may be finished to a bright polish or with a brushed finish.

In some embodiments, a set of ice mounts, such as ice mount 400, is used with one grill cleaner head, one grill cleaner handle, and one ice tray. In such embodiments, a set of ice mounts may include at least one ice mount for each cavity of the ice tray, such that each cavity of the ice tray may be used to form a block of ice around an ice mount. In such embodiments, the grill cleaner head and grill cleaner handle can be used with one ice mount at a time, such as to allow a grill cleaning operation using a first ice mount and coupled block of ice and then to allow the first ice mount to be released from the head to be replaced with a second ice mount and coupled block of ice.

In some embodiments, in using ice cleaner 100, a user freezes a block of ice, secures an elongated handle to the block of ice, and applies the block of ice to a grill in a grill cleaning operation. The user can freeze a block of ice by filling a cavity of tray 600 with a quantity of water, and then freezing the water. The user can freeze the block of ice around and through ice mount 400, specifically around ice support 420, as the ice mount 400 rests on a rim of the cavity of tray 600. The user can secure an elongated handle 300 to the block of ice by coupling embedded ice mount 400 to head 200, since head 200 is secured to handle 300. The user can then apply the block of ice to the grill in a grill cleaning operation by grasping handle 300 and manipulating handle 300 to drive head 200 such that the ice block moves within operational plane 440. The removable coupling of ice mount 400 to head 200 permits a user to switch between different ice mounts, such as to replace an ice block which has melted beyond a useable extent.

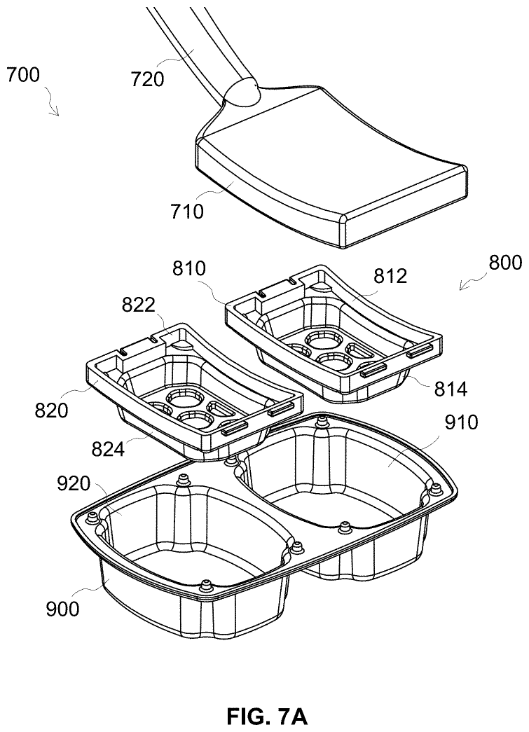

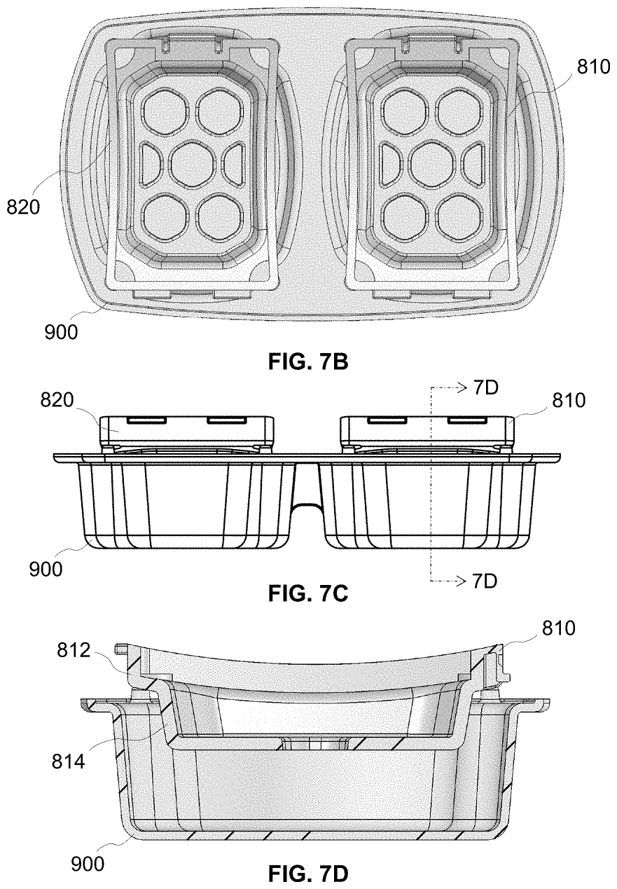

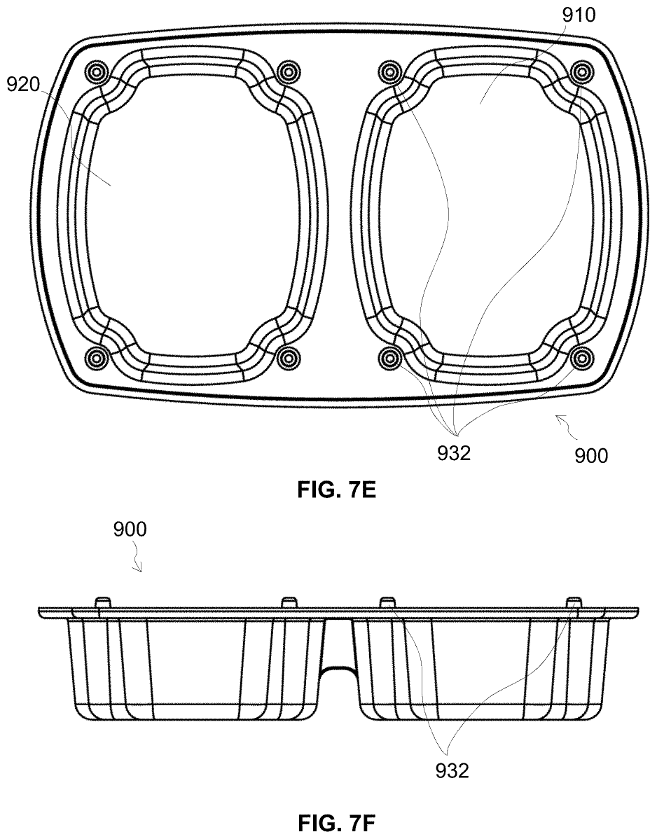

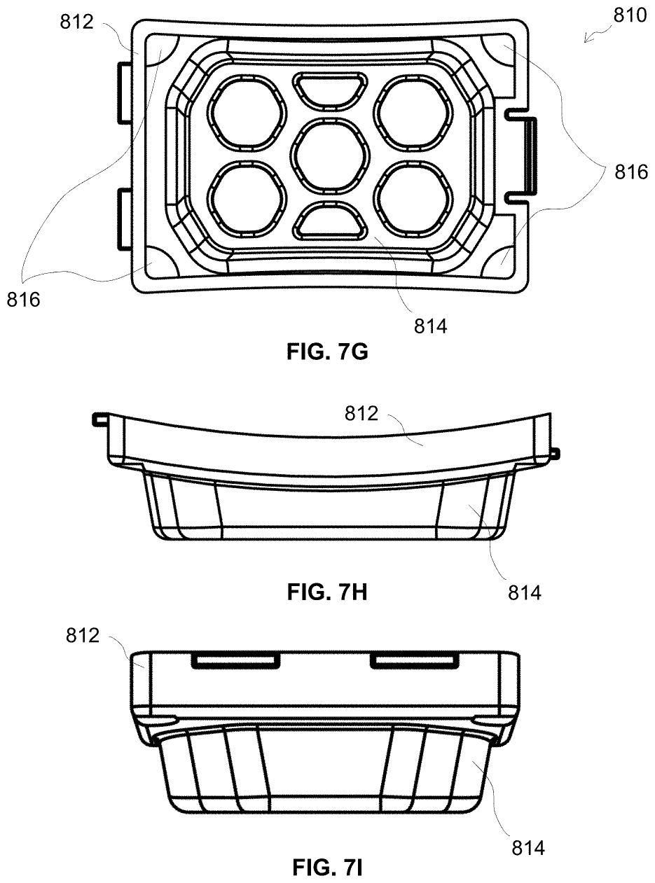

A grill cleaning system according to another embodiment is shown in FIGS. 7A to 7I, which is formed of a durable and rigid synthetic resin. Grill cleaning system 700 includes a head 710 with an elongated handle 720 extending from head 710. Grill cleaning system 700 includes a pair of ice mounts 800 and an ice tray 900. Ice mounts 800 include a first ice mount 810 and a second ice mount 820, corresponding respectively to a first cup 910 and a second cup 920 of rigid tray 900.

Head 710 and handle 720 of grill cleaning system 700 are integral pieces, with ice mounts 810 and 820 interchangeably mountable to head 710 via a spring lock system similar to spring lock system 500. Each of ice mounts 810 and 820 includes a socket insert 812 and 822 and an ice support 814 and 824. Socket insert 812 and ice support 814 are integrally formed of a synthetic resin, as are socket insert 822 and ice support 824.

Ice mounts 810 and 820 each have a set of sockets corresponding to bosses of tray 900. Sockets 816 of ice mount 810 correspond to bosses 932 near cup 910 of tray 900. Similarly, sockets of ice mount 820 correspond to bosses near cup 920 of tray 900. The corresponding sets of sockets and bosses are provided to assist in positioning ice mounts 810 and 820 in appropriate positions above cups 910 and 920, respectively. Appropriate positioning assists in ensuring that ice supports 814 and 824 are securely embedded in ice blocks which form from water held in cups 910 and 920, respectively.

Each of ice mounts 810 and 820 includes a set of apertures through the bottom to allow ice to extend through the ice mount to assist in securely embedding the ice supports 814 and 824 therein.

In some embodiments, a block of ice is formed using unaltered water, such as tap water or bottled water. In some embodiments, a block of ice is formed of scented water, flavored water, fortified water, or fluids other than water.

While the above description provides examples of one or more apparatus, methods, or systems, it will be appreciated that other apparatus, methods, or systems may be within the scope of the claims as interpreted by one of skill in the art.

1. A grill cleaner, comprising:
a) a head;
b) a handle coupled to and extending from the head, the handle oriented for use in driving the head in a grill cleaning operation; and
c) an ice mount coupled to the head and having an ice support extending from the head to be embedded within and support a block of ice.

2. (canceled)

3. The grill cleaner of claim 1, wherein the handle is an elongated handle, the handle has a handle axis and the head defines an operational plane, the handle axis forming an oblique angle with the operational plane.

4. The grill cleaner of claim 3, wherein the head has a first grill facing surface and the ice support has a second grill facing surface and a head facing surface, the head facing surface spaced from the first grill facing surface.

5. The grill cleaner of claim 4, wherein the first grill facing surface is generally convexly curved.

6. The grill cleaner of claim 4, wherein the ice support includes a support plate below the first grill facing surface of the head, the support plate defining the head facing surface and the second grill facing surface.

7. (canceled)

8. The grill cleaner of claim 5, wherein the ice mount is coupled to the head via a removable socket, the ice mount secured to the removable socket, the removable socket removably coupled to the first grill facing surface of the head.

9. The grill cleaner of claim 8, wherein the removable socket defines one or more tray projection recesses for cooperative engagement with projections on an ice tray.

10. (canceled)

11. The grill cleaner of claim 8, wherein the removable socket is removably coupled to the first grill facing surface of the head via a spring lock.

12. The grill cleaner of claim 11, wherein the head defines a socket cavity configured to receive the removable socket, the head further defining a static projection recess in a forward wall of the socket cavity and a spring projection recess in a rear wall of the socket cavity, the removable socket defining a static projection on a forward end of the removable socket and a spring projection on a rear end of the removable socket, the spring projection movable between an extended position and a retracted position, the socket cavity configured to be coupled to the head when the static projection is received in the static projection recess and the spring projection is in an extended position and received in the string projection recess.

13. A grill cleaner system comprising:
a) a grill cleaner, the grill cleaner including:
i) a head;
ii) a handle coupled to and extending from the head, the handle oriented for use in driving the head in a grill scraping operation; and
iii) an ice mount coupled to the head and having an ice support extending from the head; and
b) an ice tray having a water cavity that receives the ice support, the water cavity sized and shaped to receive a volume of water such that when frozen the volume of water will form a block of ice embedding the ice support.

14. The grill cleaner system of claim 13, wherein the head defines a first grill facing surface and the ice support defines a second grill facing surface and a head facing surface, the head facing surface spaced from the first grill facing surface.

15. The grill cleaner system of claim 14, wherein the ice support includes a support plate below the first grill facing surface of the head, the support plate defining the second grill facing surface and the head facing surface.

16. The grill cleaner system of claim 15, wherein the ice holder includes a removable socket and an ice brace, the ice brace including the ice support and secured to the removable socket, the removable socket removably coupled to the first grill facing surface of the head and configured to be received in a socket cavity of the head when coupled to the head.

17. The grill cleaner system of claim 16, wherein the removable socket is removably coupled to the first grill facing surface of the head via a spring lock.

18. The grill cleaner system of claim 17, wherein the head defines a static projection recess in a forward wall of the socket cavity and a spring projection recess in a rear wall of the socket cavity, the removable socket defining a static projection on a forward end of the removable socket and a spring projection on a rear end of the removable socket, the spring projection movable between an extended position and a retracted position, the socket cavity configured to be coupled to the head when the spring projection is received in the spring projection recess and the static projection is in an extended position and received in the static projection recess.

19. The grill cleaner system of claim 16, wherein one of the ice tray and the removable socket includes a set of guide projections and the other includes a corresponding set of guide recesses, the guide projections and guide recesses configured to align when the ice support is received in the water cavity.

20. (canceled)

21. A method of cleaning a grill, comprising:
a) freezing a block of ice;
b) securing an elongated handle to the block of ice; and
c) applying the block of ice to a grill in a grill cleaning operation.

22. The method of claim 21, wherein securing the elongated handle to the block of ice includes embedding an ice support of the handle in the block of ice.

23. (canceled)

24. (canceled)

25. (canceled)

26. The method of claim 21, wherein securing an elongated handle to the block of ice includes removably coupling an ice support embedded in the block of ice to the elongated handle.

27. The method of claim 26, wherein removably coupling the ice support embedded in the block of ice to the elongated handle includes fixing a free end of the ice support in a cavity of the elongated handle.

28. (canceled)

29. (canceled)

30. (canceled)
